(19) United States
(12) Patent Application Publication
(10) Pub. No.: US 2011/0244742 A1
(43) Pub. Date: Oct. 6, 2011

(54) Self-Adhesive Fabric Reinforced Thermoplastic Polyolefin Waterproof Membrane

(75) Inventors: Lulu HUANG, Tangshan (CN); Desheng Li, Tangshan (CN)

(73) Assignee: TANGSHAN DESHENG WATERPROOF MATERIALS CO., LTD., Hebei Province (CN)

(21) Appl. No.: 13/071,004

(22) Filed: Mar. 24, 2011

(30) Foreign Application Priority Data
Apr. 1, 2010 (CN) 201010137366.5

(51) Int. Cl. B32B 27/12; B32B 27/34; B32B 27/32

(52) U.S. Cl. 442/49; 428/221

(57) ABSTRACT

A self-adhesive fabric reinforced thermoplastic polyolefin compound waterproof membrane comprises a fabric reinforced thermoplastic polyolefin layer, a functional transition layer, a self-adhesive bitumen layer. Wherein, the fabric reinforced thermoplastic polyolefin layer comprises two thermoplastic polyolefin layers and a fabric reinforced layer between them. The thermoplastic polyolefin layer mainly comprises first-component and second-component thermoplastic polyolefins, filler, coupling agent, UV screener, antioxidant and light stabilizer. The present invention is provided with features of TPO membrane, such as environment friendly, easy processing, outstanding low-temperature performance, excellent weldability and durability, as well as advantages of self-adhesive bitumen membrane, such as easy installation, high bonding strength of substrate, watertight and fully adhered performance and reliable hot-air welding joints. It is characterized by high strength, perfect elongation, excellent low-temperature performance, high weatherability and high solar reflection, perfect flatness of roll, adequate bonding with self-adhesive bitumen and easy installation, which is a type of advanced waterproof membrane.

### FIELD OF THE INVENTION

The present invention relates to a waterproof membrane, particularly to a self-adhesive fabric reinforced thermoplastic polyolefin waterproof membrane.

### BACKGROUND OF THE INVENTION

Thermoplastic polyolefin (referred to as “TPO” hereinafter) material is a material containing carbon and hydrogen elements only, which is characterized by environment friendly, easy processing, perfect low-temperature performance, excellent weldability and durability. It has been widely applied to single-ply roofing systems in European and American countries, and the application has witnessed a year-on-year increase.

The single-ply roofing system is normally applicable to large roofs of supermarkets and plants instead of roofs of a plurality of domestic civil residential buildings of relatively smaller area. The single-ply roofing system is generally installed by means of mechanical fastening and hot-air welding. Such installation method has such advantages as quick installation and high reliability despite of such deficiencies as a plurality of accessories, expensive installation tools, damages to the roof and vulnerability to leakage as incurred by damages.

Waterproof membranes available in the market at present have such deficiencies as inadequate elongation, poor dimensional stability, inadequate flatness, inadequate bonding with self-adhesive bitumen and poor durability.

### SUMMARY OF THE INVENTION

An object of the present invention is to provide a powerful self-adhesive fabric reinforced thermoplastic polyolefin waterproof membrane characterized by high elongation, perfect low-temperature performance, excellent weatherability, high solar reflection rate and easy installation. It has overcome deficiencies to the prior art of waterproof membrane, such as low elongation, poor dimensional stability, inadequate flatness, inadequate bonding with self-adhesive bitumen and poor durability.

The self-adhesive fabric reinforced thermoplastic polyolefin waterproof membrane of the present invention at least comprises a fabric reinforced thermoplastic polyolefin layer, a functional transition layer and a self-adhesive bitumen layer, which is a multilayer membrane. The said fabric reinforced thermoplastic polyolefin layer comprises two thermoplastic polyolefin layers and one fabric reinforced layer between them; the said thermoplastic polyolefin layer mainly comprises materials of the following components and given in parts by weight: 40-60 parts by weight of first-component thermoplastic polyolefin, 40-60 parts by weight for second-component thermoplastic polyolefin, 25-50 parts by weight of a filler, 1-2 parts by weight of a coupling agent, 3-6 parts by weight of a UV screener, and 0.3-0.6 parts by weight of an antioxidant and a light stabilizer, respectively.

As compared with the prior art, self-adhesive the fabric reinforced thermoplastic polyolefin waterproof membrane of the present invention is provided with features of TPO membrane, such as environment friendly, easy processing, perfect low-temperature performance, excellent weldability and durability, as well as advantages of self-adhesive bitumen membrane, such as easy installation, high bonding strength of substrate, watertight and fully adhered performance, and reliable hot-air welding joints. It is characterized by high strength, perfect elongation, excellent low-temperature performance, high weatherability and high solar reflection rate, perfect flatness of membrane, adequate bonding with self-adhesive bitumen and easy installation, which is a type of advanced waterproof membrane.

### BRIEF DESCRIPTION OF THE DRAWINGS

FIGS. 1 and 2 are stratified structural view of the present invention, wherein there exists thickness difference between FIG. 1 and FIG. 2, in which a thermoplastic polyolefin layer 1, a fabric reinforced layer 2, a functional transition layer 3 and a self-adhesive bitumen layer 4 are as shown.

### DESCRIPTION OF THE PREFERRED EMBODIMENT

The invention is explained in further detail below in combination with the drawings.

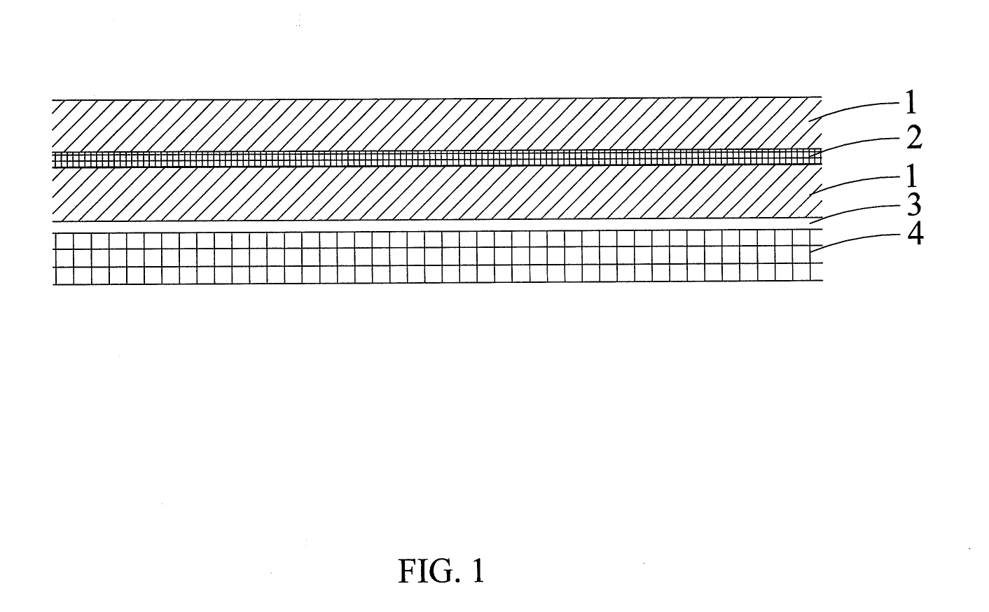

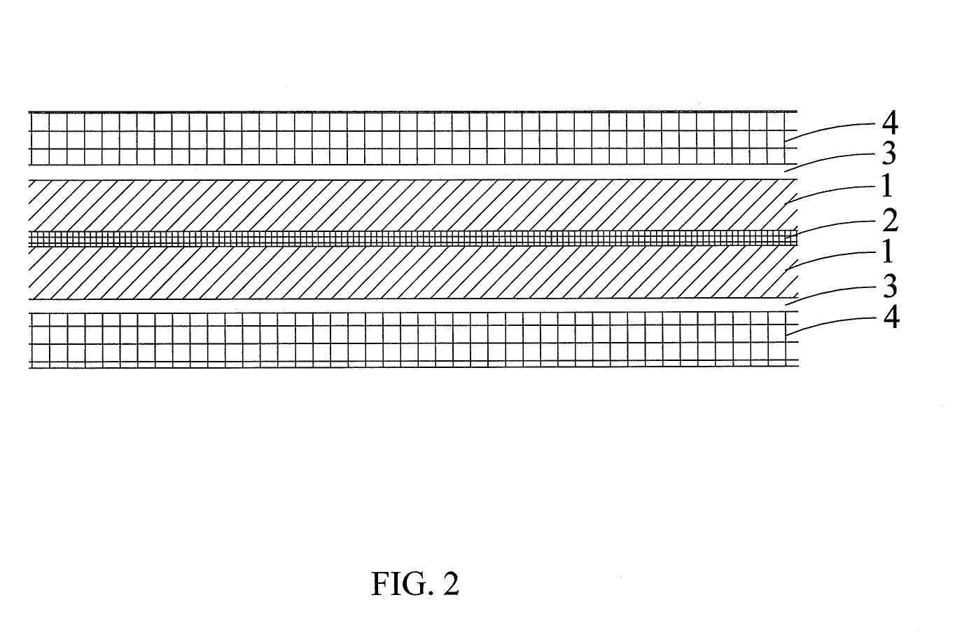

As shown in FIG. 1 and FIG. 2, a self-adhesive fabric reinforced thermoplastic polyolefin waterproof membrane of the present invention comprises at least a fabric reinforced thermoplastic polyolefin layer, a functional transition layer 3 and a self-adhesive bitumen layer 4, which is a multiplayer membrane. The fabric reinforced thermoplastic polyolefin layer comprises two thermoplastic polyolefin layers 1 and one fabric reinforced layer 2 between them with preferred total thickness ranging from 1.6 mm to 2.5 mm.

Components and parts by weight of said thermoplastic polyolefin layer are stated as follows: 60 parts by weight for first-component thermoplastic polyolefin, 40 parts by weight for second-component thermoplastic polyolefin, 30 parts by weight of a filler, 1 part by weight of a coupling agent, 5 parts by weight of a UV screener, 0.5 parts by weight of an antioxidant, and 0.5 parts by weight of a light stabilizer.

The said first-component thermoplastic polyolefin may be a propylene-ethylene copolymer, α-olefin-ethylene copolymer or propylene-ethylene-butylene terpolymer polymerized by metallocene catalysts. It is applicable to use products available in the market, such as VERSIFY 2300 and 2400 as manufactured by Dow Chemical. Such TPO can provide excellent flexibility, penetration resistance and weldability.

The second-component thermoplastic polyolefin may be linear low density polyethylene, low density polyethylene or polypropylene with a melt index ranging from 0.5 to 5 and determined in accordance with ASTM D1238. It is applicable to use products available in the market, such as linear low density polyethylene 7042 and polypropylene K8003 as manufactured by Sinopec Yangzi Petrochemical Co., Ltd. Such resins can provide perfect mechanical performance and heat resistance.

The filler may be light or heavy calcium carbonate, magnesium hydroxide or aluminum hydroxide ranging from 1250 meshes to 5000 meshes. It is applicable to use products available in the market, such as light calcium carbonate of 3000 meshes as manufactured by Tianjin Juntong Technical Development Limited Company, which is available for improvement of heat and creep resistance as well as reduction of cost. Magnesium hydroxide or aluminum hydroxide used is favorable for improvement of flame retardancy of the waterproof membrane. All figures given in “meshes” have been determined herein according to Tyler Standard screen scale.

The coupling agent may be titanate or aluminate. 1 part by weight of the coupling agent is added into 30 parts by weight filler for high-speed mixing so as to carry out surface treatment to the filler. Such treatment can improve the interface bonding between resin and the filler to minimize the influence on mechanical performance of the waterproof membrane.

The UV screener may be titanium dioxide or carbon black. It is applicable to use products available in the market, such as DUPONT R5566 titanium dioxide and CABOT 234 carbon black. Titanium dioxide or carbon black or both according to specific purposes or requirements is added. Such UV screener has such functions as ultraviolet shielding and promotion of solar reflection rate.

The antioxidant may be 1076 antioxidant (chemical name: n-octadecyl-β-(4-hydroxy-3,5-di-tert-butyl-phenyl) propionate), 3114 antioxidant (chemical name: 1,3,5-tris(3,5-di-tert-butyl-4-hydroxybenzyl)-1,3,5-triazine-2,4,6-[1H, 3H, 5H]trione) or DLDP antioxidant (chemical name: dilauryl thiodipropionate). It is applicable to use products available in the market, such as 1076 antioxidant as manufactured by Beijing San'an Chemical Product Co., Ltd. Such antioxidants aim to reduce the thermal degradation during processing and use.

The light stabilizer may be 944 light stabilizer (chemical name: poly-[[6-[(1,1,3,3-tetramethylbutyl)amino]-1,3,5-triazine-2,4-diyl]-[(2,2,6,6-tetramethyl-4-piperidyl)imino]-1,6-hexanediyl-[(2,2,6,6-tetramethyl-4-piperidyl) imino]]), 783 light stabilizer (chemical name: poly-[[6-[(1,1,3,3-tetramethylbutyl)imino]-1,3,5-triazine-2,4-diyl]-[2-(2,2,6,6-tetramethylpiperidyl)amino]-hexamethylene-[4-(2,2,6,6-tetramethylpiperidyl)imino]] and poly-[N-β-hydroxyethyl-2,2,6,6-tetramethyl-4-hydroxy-piperidyl succinate] compound) or 622 light stabilizer (chemical name: poly-[N-β-hydroxyethyl-2,2,6,6-tetramethyl-4-hydroxy-piperidyl succinate]). It is applicable to use products available in the market, such as 944 light stabilizer as manufactured by Beijing San'an Chemical Product Co., Ltd. Such light stabilizer aim to reduce photodegradation of waterproof membrane during use.

A preferred fabric reinforced layer is warp-knitted nylon scrim. It has higher strength and perfect tearing strength and penetration resistance as compared with warp-knitted polyester scrim.

A preferred functional transition layer is an aluminum film or an aluminum plastic film. It has such functions as improvement of composite strength of self-adhesive bitumen and the TPO membrane, reflection of partial infrared and far infrared wave, and thermal insulation.

The thickness of preferred self-adhesive bitumen layer ranges from 0.3 mm to 0.7 mm. It is applicable to installation with a fully adhered method, wet installed method and pre-applied method, which is characterized by high efficiency and installation speed and watertight firm bonding with the substrate.

### Embodiment 1

As shown in FIG. 1, the self-adhesive fabric reinforced thermoplastic polyolefin waterproof membrane has a total thickness of 1.8 mm, which comprises two thermoplastic polyolefin layers 1, one fabric reinforced layer 2, one transition layer 3 and one self-adhesive bitumen layer 4. Its layout sequence is as shown in FIG. 1: thermoplastic polyolefin layer 1-fabric reinforced layer 2-thermoplastic polyolefin layer 1-transition layer 3-self-adhesive bitumen layer 4. The thickness of the self-adhesive bitumen layer 4 is 0.6 mm. It is a five-layer structural membrane.

Components and parts by weight of thermoplastic polyolefin layer as shown in FIG. 1 are as follows: 60 parts by weight for first-component thermoplastic polyolefin, 40 parts by weight for second-component thermoplastic polyolefin, 30 parts by weight of a filler, 1 part by weight of a coupling agent, 5 parts by weight of a UV screener, 0.5 parts by weight of an antioxidant, and 0.5 parts by weight of a light stabilizer.

The first-component thermoplastic polyolefin is VERSIFY 2300 as manufactured by Dow Chemical.

The second-component thermoplastic polyolefin is 7042 linear low density polyethylene as manufactured by Sinopec Yangzi Petrochemical Co., Ltd.

The filler is light calcium carbonate of 3000 meshes as manufactured by Tianjin Juntong Technical Development Limited Company.

The coupling agent is titanate coupling agent.

The UV screener is DUPONT R5566 titanium pigment.

The antioxidant is 1076 antioxidant as manufactured by Beijing San'an Chemical Product Co., Ltd.

The light stabilizer is 944 light stabilizer as manufactured by Beijing San'an Chemical Product Co., Ltd.

The fabric reinforced layer is warp-knitted nylon scrim.

The functional transition layer is an aluminum film.

The self-adhesive bitumen layer has a thickness of 0.6 mm.

Results of test according to Q/RDSC04-2009 Enterprise Standard are stated as follows:

| | | Technical | | Actual |
|---|---|---|---|---|
| No. | Items Tested | Indicators | | Indicators |
| 1 | Tension, N/5 cm ≧ | 800 | | 820 |
| 2 | Elongation at break, % ≧ | 600 | | 795 |
| 3 | Low-temperature bending | −40, no crack | | No crack |
| | property, ° C. | | | |
| 4 | Impermeability | 0.5 | MPa | Impermeable |

| | | | Impermeable for | |
|---|---|---|---|---|
| | | | 120 min | |
| 5 | Peel strength of self-adhesive | | 1.5 | 2.2 |
| | bitumen surface, adhesion to | | | |
| | aluminum plate N/mm ≧ | | | |
| 6 | Tearing strength, N ≧ | | 70 | 77.6 |
| 7 | Heat resistance of self-adhesive | | 80° C., sliding no | Acceptable |
| | bitumen surface | | more than 2 mm | |
| 8 | Heat aging | Tension | ±20 | −8.3 |
| | (70° C., | variation, % | | |
| | 168 h) | Elongation | ±20 | −2.1 |
| | | variation, % | | |
| | | Low-temperature | −35, no crack | No crack |
| | | bending property | | |
| 9 | Artificial | Appearance | No crack and | Acceptable |
| | weathering, | | lamination | |
| | 2500 h | Tension reservation | 90 | 92.4 |
| | | rate % ≧ | | |
| | | Elongation | 90 | 97.6 |
| | | reservation rate, % ≧ | | |
| | | Low-temperature | −40° C., no crack | No crack |
| | | bending property | | |

### Embodiment 2

As shown in FIG. 2, the self-adhesive fabric reinforced thermoplastic polyolefin waterproof membrane has a total thickness of 2.0 mm, which comprises two thermoplastic polyolefin layers 1, one fabric reinforced layer 2, two transition layers 3 and two self-adhesive bitumen layers 4; the thickness of the self-adhesive bitumen layer 4 is 0.5 mm. Its layout sequence is as follows: self-adhesive bitumen layer 4-transition layer 3-thermoplastic polyolefin layer 1-fabric reinforced layer 2-thermoplastic polyolefin layer 1-transition layer 3-self-adhesive bitumen layer 4. It is a seven-layer structure.

Components and parts by weight of thermoplastic polyolefin layer as shown in FIG. 2 are stated as follows: 60 parts by weight for first-component thermoplastic polyolefin, 40 parts by weight for second-component thermoplastic polyolefin, 25 parts by weight of a filler, 1 part by weight of a coupling agent, 5 parts by weight of a UV screener, 0.5 parts by weight of an antioxidant, and 0.5 parts by weight of a light stabilizer.

The first-component thermoplastic polyolefin is Softtell CA02A as manufactured by Lyondell Basell.

The second-component thermoplastic polyolefin is 2420F low density polyethylene as manufactured by CNOOC and Shell Petrochemicals Company Limited.

The filler is light calcium carbonate of 3000 meshes as manufactured by Tianjin Juntong Technical Development Limited Company.

The coupling agent is of titanate type.

The UV screener is DUPONT R5566 titanium dioxide and Cabot 234 carbon black batched at the proportion of 4:1.

The antioxidant is 3114 antioxidant as manufactured by Beijing San'an Chemical Product Co., Ltd.

The light stabilizer is 783 light stabilizer as manufactured by Beijing San'an Chemical Product Co., Ltd.

The fabric reinforced layer is warp-knitted nylon scrim.

The functional transition layer is an aluminum film.

The self-adhesive bitumen layer has a thickness of 0.5 mm.

Results of test according to Q/RDSC04-2009 Enterprise Standard are stated as follows:

| | | Technical | | Actual |
|---|---|---|---|---|
| No. | Items Tested | Indicators | | Indicators |
| 1 | Tension, N/5 cm ≧ | 800 | | 817 |
| 2 | Elongation at break, % ≧ | 600 | | 783 |
| 3 | Low-temperature bending | −40, no crack | | No crack |
| | property, □ | | | |
| 4 | Impermeability | 0.5 | MPa | Impermeable |

| | | | Impermeable for | |
|---|---|---|---|---|
| | | | 120 min | |
| 5 | Peel strength of self-adhesive | | 1.5 | 2.4 |
| | bitumen surface, adhesion to | | | |
| | aluminum plate N/mm ≧ | | | |
| 6 | Tearing strength, N ≧ | | 70 | 78.5 |
| 7 | Heat resistance of self-adhesive | | 80□, sliding no | Acceptable |
| | bitumen surface | | more than 2 mm | |
| 8 | Heat aging | Tension | ±20 | −9.1 |
| | (70□, 168 h) | variation, % | | |
| | | Elongation | ±20 | −2.7 |
| | | variation, % | | |
| | | Low-temperature | −35, no crack | No crack |
| | | bending property | | |
| 9 | Artificial | Appearance | No crack and | Acceptable |
| | weathering, | | lamination | |
| | 2500 h | Tension reservation | 90 | 92.1 |
| | | rate %, ≧ | | |
| | | Elongation | 90 | 97.2 |
| | | reservation rate, % ≧ | | |
| | | Low-temperature | −40□, no crack | No crack |
| | | bending property | | |

Number of layers and thickness of this invention are selected as per design demands.

Disclosed above are embodiments of this invention. Despite of preferred embodiments as disclosed above, this invention is not limited thereby. Any variation as considered by technical personnel in this field for alteration and modification of this invention shall be incorporated into the protection scope of this invention unless it is deviated from the design conception of this invention.

What is claimed is:

1. A self-adhesive fabric reinforced thermoplastic polyolefin waterproof membrane, at least comprising a fabric reinforced thermoplastic polyolefin layer, a functional transition layer and a self-adhesive bitumen layer, which is a multilayer membrane; the said fabric reinforced thermoplastic polyolefin layer comprising two thermoplastic polyolefin layers and a fabric reinforced layer between them; the said thermoplastic polyolefin layers mainly comprising materials of the following components given in parts by weight: 40-60 parts by weight for first-component thermoplastic polyolefin, 40-60 parts by weight for second-component thermoplastic polyolefin, 25-50 parts by weight of a filler, 1-2 parts by weight of a coupling agent, 3-6 parts by weight of a UV screener, 0.3-0.6 parts by weight of an antioxidant, and 0.3-0.6 parts by weight of a light stabilizer.

2. The self-adhesive fabric reinforced thermoplastic polyolefin waterproof membrane according to claim 1, wherein the first-component thermoplastic polyolefin of the thermoplastic polyolefin layer is propylene-ethylene copolymer, α-olefin-ethylene copolymer or propylene-ethylene-butylene terpolymer polymerized by metallocene catalysts;
the second-component thermoplastic polyolefin is linear low density polyethylene, low density polyethylene or polypropylene with a melt index ranging from 0.5 to 5 as determined by ASTM D1238;
the filler is light or heavy calcium carbonate, magnesium hydroxide or aluminum hydroxide ranging from 1-250 meshes to 5-000 meshes;
the coupling agent is titanate or aluminate coupling agent;
the UV screener is titanium dioxide or carbon black;
the antioxidant is 1076, 3114 or DLDP antioxidant; and
the light stabilizer is 944, 783 or 622 light stabilizer.

3. The self-adhesive fabric reinforced thermoplastic polyolefin waterproof membrane according to claim 1, wherein the fabric reinforced layer is weaved nylon scrim.

4. The self-adhesive fabric reinforced thermoplastic polyolefin waterproof membrane according to claim 1, wherein the fabric reinforced layer is an aluminum film or an aluminum plastic film.

5. The self-adhesive fabric reinforced thermoplastic polyolefin waterproof membrane according to claim 1, wherein the thickness of the self-adhesive bitumen layer is 0.3-0.7 mm.
